(19) United States
(12) Patent Application Publication
(10) Pub. No.: US 2013/0339591 A1
(43) Pub. Date: Dec. 19, 2013

(54) RELAYING APPARATUS, RELAY HISTORY RECORDING METHOD, AND DATA PROCESSING APPARATUS

(71) Applicant: FUJITSU LIMITED, Kawasaki-shi (JP)

(72) Inventors: Jin Takahashi, Bunkyo (JP); Masanori Higeta, Setagaya (JP); Shintaro Itozawa, Kawasaki (JP); Masahiro NISHIO, Yokohama (JP); Hiroshi Nakayama, Yokohama (JP); Junji Ichimiya, Yokohama (JP)

(73) Assignee: FUJITSU LIMITED, Kawasaki-shi (JP)

(21) Appl. No.: 13/961,912

(22) Filed: Aug. 8, 2013

Related U.S. Application Data
(63) Continuation of application No. PCT/JP2011/052792, filed on Feb. 9, 2011.

(51) Int. Cl. G06F 12/00

(52) U.S. Cl. CPC G06F 12/00
USPC 711/104

(57) ABSTRACT

When a relaying apparatus receives communication unit data transmitted from a processing apparatus that performs data processing, the relaying apparatus extracts preset data from the received communication unit data as trace information and calculates the number of pieces of the received communication unit data. History information of the received communication unit data is selected from the extracted trace information and statistical information obtained from the result of the calculation. The selected information is recorded in a storage apparatus available to the processing apparatus.

### CROSS-REFERENCE TO RELATED APPLICATION

This application is a continuation application of International Application PCT/JP2011/052792 filed on Feb. 9, 2011 and designated the U.S., the entire contents of which are incorporated herein by reference.

### FIELD

The embodiments discussed herein are related to a technology for relaying communication unit data (e.g., packets) transmitted and received between processing apparatuses that perform data processing.

### BACKGROUND

Data is divided into pieces of communication unit data (hereinafter referred to as “packets”) in a preset format typified by a packet and then transmitted or received between processing apparatuses that perform data processing. Typically, the rate of the transferring of data within processing apparatuses is significantly higher than the rate of the transferring of data through a communication path between the processing apparatuses. This is one of the reasons why packets are ordinarily transmitted and received between processing apparatus via a relaying apparatus.

Some relaying apparatuses can record history information that indicates packet relay operations so as to prepare for, for example, an occurrence of a fault. To record or save history information, relatively fast memories such as RAMs are typically used. In order to record a huge volume of history information, a memory connected to a relaying apparatus is used to record the history information. History information is stored in a memory prepared in addition to a relaying apparatus, partly because large capacity memories have been available at low cost.

Installing a large capacity built-in random access memory (RAM) in relaying apparatuses greatly increases the cost for fabricating the relaying apparatuses and also extends the development period. Accordingly, in comparison with a situation in which a large capacity memory is installed in relaying apparatuses, adopting reasonable memories has the advantages of a lower cost of manufacture and a shorter development period.

Memories connected to a relaying apparatus are not necessarily used exclusively to record history information. That is, with reference to a memory in which history information is recorded, a relaying apparatus to which this memory is connected may possibly be used for another application, or this memory may possibly be used by another apparatus. For such a memory that is used for a plurality of applications (hereinafter referred to as a “shared memory” for convenience), accesses from, for example, apparatuses that are different from a relaying apparatus concentrate on the shared memory. That is, there is a very strong possibility that a request to access the shared memory is made very often per unit time.

Recording history information from the relaying apparatus while accesses from other apparatuses concentrate on the shared memory will disturb accesses from these other apparatuses to the shared memory. If these other apparatuses are processing apparatuses such as CPUs (Central Processing Unit) that perform data processing, accesses from the CPUs to the shared memory are disturbed, so the data processing speed could significantly decrease. A considerable decrease in the data processing speed of the CPU is undesirable since it could largely deteriorate the overall performance of the apparatus. Thus, in order to record history information in the shared memory, it is important to consider an access from an apparatus that is different from the relaying apparatus.

Patent document 1: Japanese Laid-open Patent Publication No. 2000-307681

Patent document 2: Japanese Laid-open Patent Publication No. 11-312098

### SUMMARY

One system to which the present invention has been applied includes: an information extracting unit that, when communication unit data (e.g., a packet) transmitted from a processing apparatus that performs data processing is received, extracts preset data from the received communication unit data as trace information; an access unit that accesses a storage apparatus available to the processing apparatus; a calculating unit that calculates the number of pieces of the received communication unit data; and an information selecting unit that selects, as history information of the received communication unit data, an object to be stored in the storage apparatus from among the trace information extracted by the information extracting unit and statistical information obtained from the calculation result of the calculating unit, and that causes the access unit to store the selected history information in the storage apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration of a data processing apparatus in accordance with the present embodiment.

FIG. 2 illustrates a configuration of a packet relayed by an NC (node controller) provided with a replaying apparatus in accordance with the present embodiment.

FIG. 3 illustrates an address map of a memory connected to an NC provided with a replaying apparatus in accordance with the present embodiment.

FIG. 4 illustrates a configuration of an NC provided with a relaying apparatus in accordance with the present embodiment.

FIG. 5 illustrates a configuration of a trace record circuit and an MC.

FIG. 6 illustrates a specific exemplary configuration of a trace record circuit.

FIG. 7 illustrates a configuration of a comparing unit.

FIG. 8 illustrates contents of a configuration file that is used to make a setting for a trace record circuit.

FIG. 9 illustrates history information stored in a memory by an NC provided with a relaying apparatus in accordance with the present embodiment.

FIG. 10 is a flowchart illustrating the flow of processes performed to make a setting for a trace record circuit.

### DESCRIPTION OF EMBODIMENTS

An object of the present invention is to provide a technology for, in accordance with a situation of an access to a memory used for a plurality of applications, allowing history information that indicates an operation of relaying communication unit data to be recorded in the memory.

In the following, embodiments of the present invention will be described in detail with reference to the drawings.

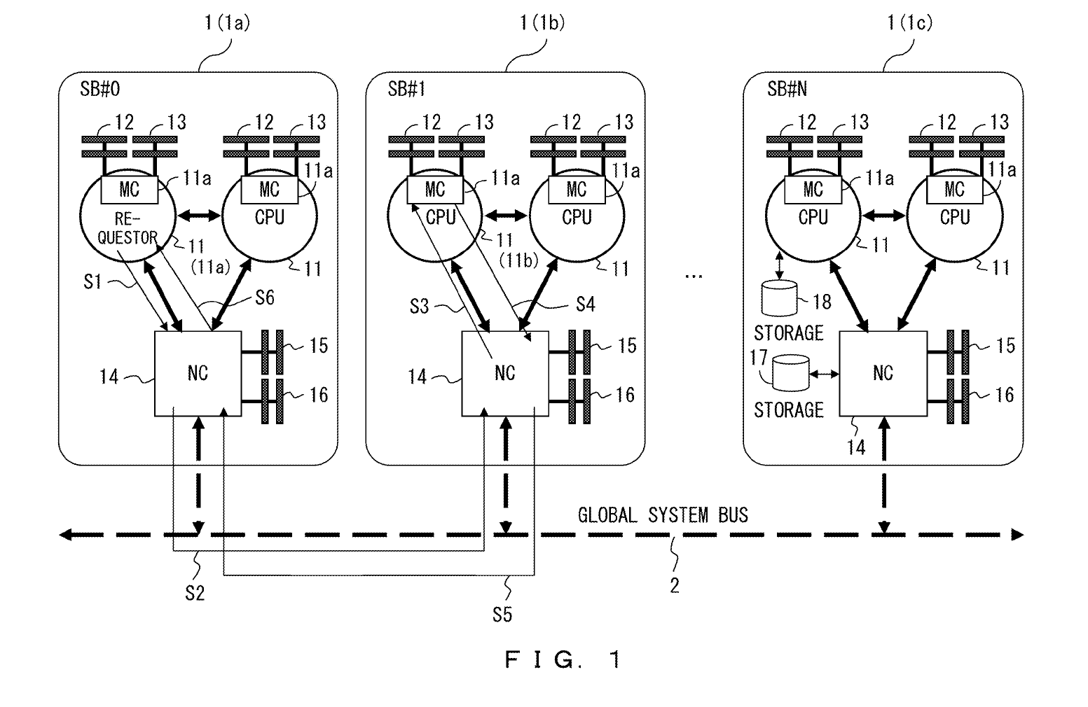

FIG. 1 illustrates a configuration of a data processing apparatus in accordance with the present embodiment.

A data processing apparatus (a computer) connects a plurality of system boards 1 each corresponding to one computer to a global system bus 2 so that data can be transmitted and received between the system boards 1. Three system boards 1a to 1c are depicted as the system boards 1 in FIG. 1.

A plurality of nodes (two nodes in the case of FIG. 1) including a CPU 11 and DIMMS (Dual Inline Memory Modules) (e.g., SDRAM modules) 12 and 13 connected to the CPU 11 are installed on each system board 1, and the CPU 11 of each node is connected to the CPU 11 of the other node. Accordingly, the computer illustrated in FIG. 1 employs NUMA (Non-Uniform Memory Access). The CPU 11 of each node is connected to an NC (a node controller) 14, and at least DIMMS (e.g., SDRAM modules) 15 and 16 are also connected to the NC 14. In this example, assume for convenience that the same data is stored in the DIMMS 12 and 13 connected to each CPU 11 and in the DIMMS 15 and 16 connected to the NC 14 in order to, for example, improve reliability (safety).

An MC (Memory Controller) 11a to access the DIMMS 12 and 13 is installed in each CPU 11. For example, an SSD (Solid State Drive) or a storage 18, which is a hard disk apparatus, is connectable to each CPU 11, and, with reference to the system board 1c, the storage 18 is connected to the CPU 11.

Although not particularly illustrated, for example, a ROM that stores a BIOS (Basic Input/Output System) for start-up and so on is connected to each CPU 11 or to a predetermined CPU 11. The ROM is connected to, for example, at least one CPU 11 for each system board 1, so that the BIOS from the ROM can be loaded into all of the CPUs 11 within the system board 1 through communication between the CPUs 11 within the system board 1. The CPU 11 into which the BIOS has been loaded may obtain data from, for example, another system board 1 so that an OS (Operating System), an application program, and so on can be stored in optional locations.

A storage 17 is also connectable to each NC 14, and, in the example in FIG. 1, the storage 17 is connected to the NC 14 installed on the system board 1c. The NC 14 relays data transmission and reception performed between the system boards 1 via the global system bus 2. Accordingly, the relaying apparatus in accordance with the present embodiment is installed in the NC 14. The data processing apparatus in accordance with the present embodiment is achieved by installing the NC 14.

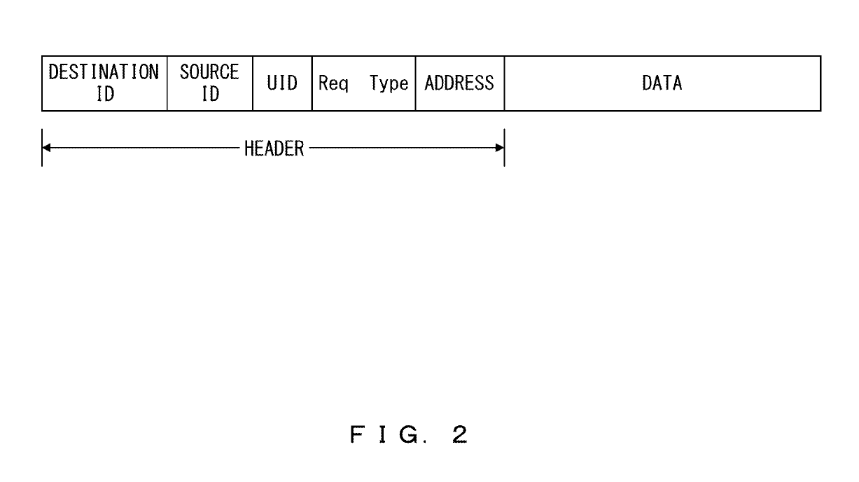

Data is transmitted and received using a packet that is communication unit data having a configuration as illustrated in FIG. 2. As illustrated in FIG. 2, the packet includes: a destination ID indicating a CPU 11 that is a destination of the packet; a source ID indicating a CPU 11 that is a source of the packet; a unique ID to identify the packet (referred to as “UID” in FIG. 2); a request type indicating a content requested by the packet (referred to as “Req Type” in FIG. 2); an address to be accessed in accordance with the content designated by the request type; and a data division in which a data body is stored. The destination ID, the source ID, the UID, the request type, and the address form a header division.

The configuration of packets is not limited to the one illustrated in FIG. 2. Communication unit data may be an element that is different from a packet.

As described in the following, data is transmitted and received using the packet as illustrated in FIG. 2. Here, descriptions will be given of an exemplary situation in which one CPU 11 of the system board 1a obtains data from one CPU 11b of the system board 1b. In FIG. 1, the CPU 11a of the system board 1a that is the source of a data request is referred to as a “requestor”.

The CPU 11 of the system board 1a generates and transmits to the NC 14 of the system board 1a a packet that is addressed to the CPU 11 of the system board 1b and that makes a request to transmit necessary data (sequence S1). The destination ID and the source ID of this generated packet are used within the system board la. Accordingly, the NC 14 of the system board 1a converts the destination ID and the source ID of the packet received from the CPU 11a of the system board 1a into those common to the system boards 1, and outputs the packet after the converting to the global system bus 2. Then, the NC 14 of the system board 1b captures the packet output from the system board 1a to the global system bus 2 (the processes above are included in sequence S2).

The NC 14 of the system board 1b converts the destination ID and the source ID of the captured packet into those used within the system board 1d, and transmits the packet after the converting to the CPU 11b of the system board 1b (sequence S3). The CPU 11b, which has received the packet, reads data designated by the packet from, for example, the DIMMS 12 or 13 connected thereto, and generates and transmits to the NC 14 a packet that includes a data division in which the read data is stored (sequence S4).

The NC 14 of the system board 1b converts the destination ID and the source ID of the received packet into those common to the system boards 1, and outputs the packet after the converting to the global system bus 2. Then, the NC 14 of the system board 1a captures the packet output to the global system bus 2 (the processes above are included in sequence S5).

The NC 14 of the system board 1a converts the destination ID and the source ID of the captured packet into those used within the system board la, and transmits the packet after the converting to the CPU (requestor) 11a (sequence S6). Accordingly, the CPU 11a obtains the designated data from the CPU 11b of the system board 1b.

With reference to a data processing apparatus having the configuration as illustrated in FIG. 1, packets (data) are transmitted and received between the system boards 1 as described above. Packets are transmitted or received via the global system bus 2 that achieves a relatively low transmission rate, so packet transmission or reception via the global system bus 2 largely affects the respective processing performances of the system boards 1 and the data processing apparatus. This is also why the NC 14 of each system board 1 records in the DIMMS 15 and 16 history information that indicates packet relay operations. The recorded history information is used for a simulation conducted during the development of a next product and is used, for example, to investigate a cause of an error that has occurred and to analyze an access pattern that causes a performance problem.

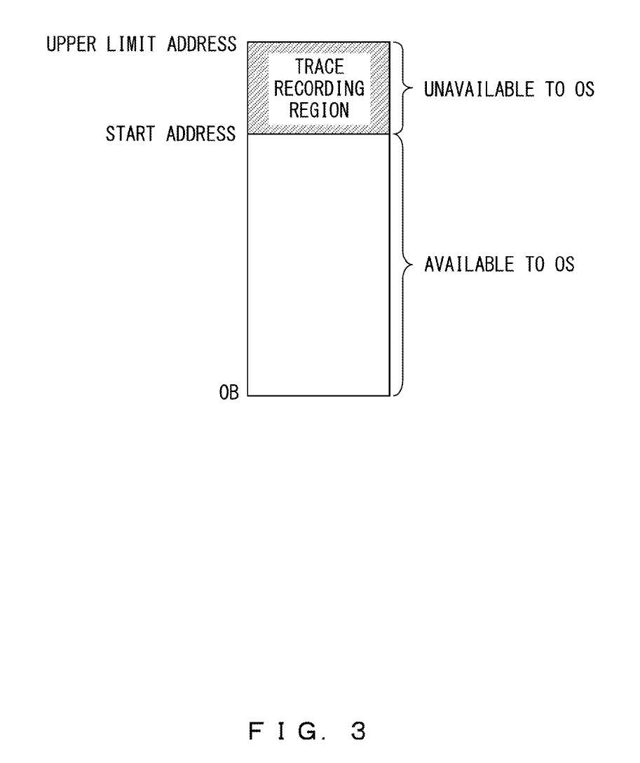

FIG. 3 illustrates an address map of a memory area of the DIMMS 15 and 16 connected to the NC 14. As illustrated in FIG. 3, the memory area of the DIMMS 15 and 16 include a trace recording region to store history information indicating a packet relay operation and another region that can be used by, for example, each CPU 11 of each system board 1. “AVAILABLE TO OS” in FIG. 3 means that the region is available to each CPU 11. “UNAVAILABLE TO OS” means here that the region is available to only the NC 14. More particularly, “available to only the NC 14” means that only the NC 14 can store data. “START ADDRESS” means the leading address of the trace recording region, and “UPPER LIMIT ADDRESS” means the final address of the trace recording region.

The plurality of system boards 1 may be divided into a plurality of partitions. In this case, the DIMMS 15 and 16 connected to the NC 14 of each system board 1 are available to each CPU 11 installed on the system boards 1 belonging to the same partition. In this example, assume for convenience that the DIMMS 15 and 16 connected to the NC 14 of each system board 1 are available to all of the CPUs 11 installed on every system board 1.

As illustrated in FIG. 3, the DIMMS 15 and 16 in which each NC 14 stores history information are also available to each CPU 11 of each system board 1. A request to allow the DIMMS 15 and 16 that are available to a plurality of apparatuses, i.e., that are used for a plurality of applications, to be accessed may possibly be made very often per unit time. Recording history information from the NC 14 while accesses from one or more CPUs 11 that can use the DIMMS 15 and 16 concentrate will disturb the accesses from these CPUs 11. Such an inhibition of the accesses decreases the processing capacity of the CPUs 11 and, in addition, the processing capacity of the entirety of the data processing apparatus. Accordingly, the present embodiment allows history information that depends on a situation of an access to the DIMMS 15 and 16 to be automatically stored in the NC 14. In the following, the NC 14 will be described in detail.

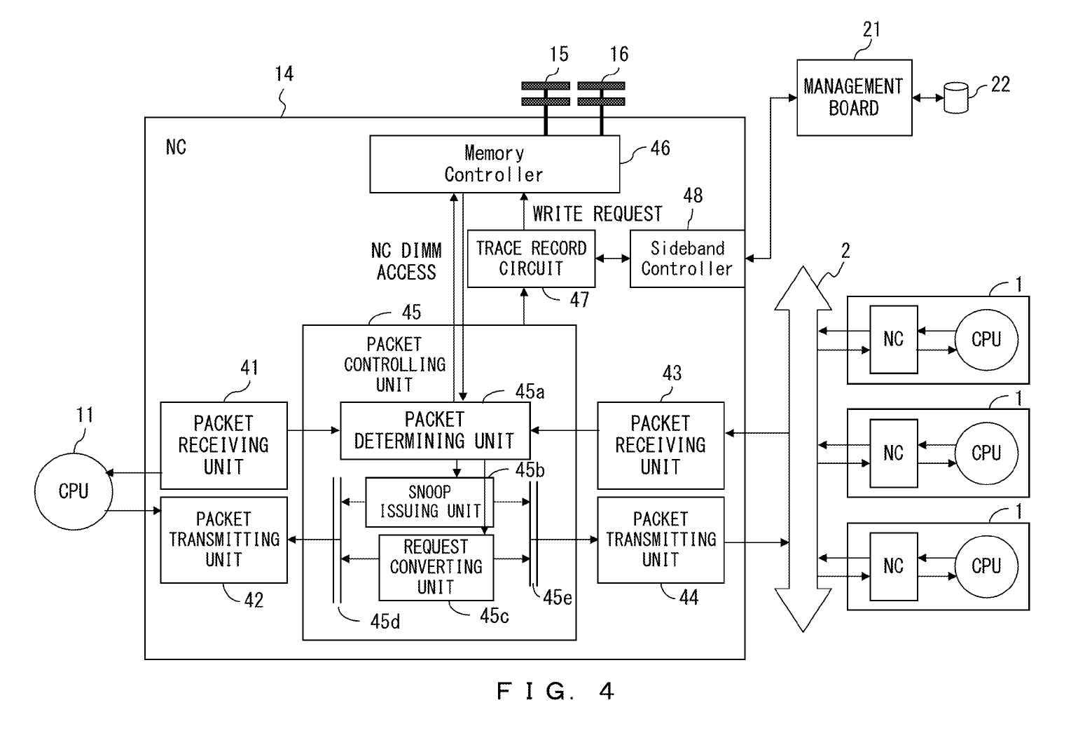

FIG. 4 illustrates a configuration of the NC 14.

As illustrated in FIG. 4, the NC 14 includes: a packet receiving unit 41 that receives a packet transmitted from the CPU 11; a packet transmitting unit 42 that transmits a packet to the CPU 11; a packet receiving unit 43 that receives a packet that has been transmitted to the global system bus 2; a packet transmitting unit 44 that outputs a packet to the global system bus 2; and a packet controlling unit 45 that controls packet relay. The NC 14 further includes: an MC (Memory Controller) 46 that accesses the DIMMS 15 and 16; a trace record circuit 47 that controls the storing of history information; and an SC (Sideband Controller) 48 for connection to a management board 21. The management board 21 is, for example, an apparatus to manage the data processing apparatus. FIG. 4 depicts for convenience only one CPU 11 within the same system board 1, but a plurality of CPUs 11 are actually present in each of the system boards 1. The packet receiving unit 41 and the packet transmitting unit 42 are also provided for each of the CPUs 11.

The packet controlling unit 45 includes a packet determining unit 45a, a snoop issuing unit 45b, a request converting unit 45c, and two selectors 45d and 45e.

Upon receipt of a packet from the packet receiving unit 41 or 43, the packet determining unit 45a specifies a content requested by the received packet and gives an instruction to at least one of the snoop issuing unit 45b or the request converting unit 45c.

In the case of a data processing apparatus that includes a plurality of CPUs, one or more CPUs may save, in a cache memory, data stored in a certain memory. Thus, the coherency between the cache memory and the memory needs to be maintained. The present embodiment employs a snoop scheme to achieve the coherency. To achieve the coherency, the snoop issuing unit 45b issues a snoop message, which is a type of a packet. The coherency may be achieved using a scheme that is different from the snoop scheme. Other existing schemes such as a directory scheme may also be used.

Data (cache lines) within the cache memory are in any of the four states, M (Modified), E (exclusive), S (Shared), and I (Invalid). An M state is a state in which data is present only within the cache memory and the data has been changed relative to a value in a memory (a memory in which the data is stored). An E state is a state in which data is present only within the cache memory but is identical with the value in a memory. An S state is a state in which data is present in a plurality of cache memories. An I state is a state in which data within a cache memory is invalid. Information that indicates which of the four states data is in is typically stored in a tag in a cache line. This information is reflected in the request type of a packet.

To obtain, for example, data that is in the M state from the DIMMS 12 and 13, before the data is read from the DIMMS 12 and 13, changed data within a cache memory needs to be written to the DIMMS 12 and 13. To write data that is in the S state to the DIMMS 12 and 13, data within another cache memory needs to be put in the I state. Thus, a snoop message to achieve coherency is also output to the global system bus 2. Accordingly, the packet determining unit 45a 1 receives the snoop message from the packet receiving unit 43 in addition to a packet. A packet that is a message for interruption is also output from the packet receiving unit 43 to the packet determining unit 45a.

Upon receipt of the snoop message from the packet receiving unit 43, the packet determining unit 45a instructs the snoop issuing unit 45b to issue a snoop message. This snoop message is transmitted to, for example, each CPU 11 within the same system board 1. Accordingly, the issued snoop message is transmitted via the selector 45d and the packet transmitting unit 42 to each CPU 11 within the same system board 1.

When a packet that is different from a snoop message is input from the packet receiving unit 43, the packet determining unit 45a outputs the input packet to the request converting unit 45c and causes the request converting unit 45c to generate a packet that includes a converted destination ID and a converted source ID. The generated packet is transmitted via the selector 45d and a corresponding packet transmitting unit 42 to a corresponding CPU 11. The destination ID and the source ID are converted by respectively replacing them with, for example, a local ID of a CPU 11 that is used within the same system board 1 and a local ID of the NC 14 itself.

When a packet is input from the packet receiving unit 41, the packet determining unit 45a determines whether or not a snoop message needs to be issued, and, if necessary, instructs the snoop issuing unit 45b to issue a snoop message. When a snoop message is issued, the packet determining unit 45a causes the snoop message to be output to the global system bus 2 via the selector 45e, then outputs the input packet to the request converting unit 45c, and finally causes the request converting unit 45c to generate a packet that includes a converted destination ID and a converted source ID. The packet generated by the request converting unit 45c is output to the global system bus 2 via the selector 45e. When a snoop message does not need to be issued, the packet determining unit 45a immediately outputs the input packet to the request converting unit 45c and causes the request converting unit 45c to generate a packet that includes a converted destination ID and a converted source ID. The destination ID is converted by replacing it with, for example, a global ID that is common to the system boards 1 and that is allocated to a CPU 11 of a system board 1 to which the packet needs to be transmitted, and the source ID is converted by replacing it with, for example, a global ID of the NC 14 itself.

Packets received by the packet receiving units 41 and 43 may include a packet that requests an access to the DIMMS 15 and 16 connected to the NC 14. When such a packet is input, the packet determining unit 45a instructs the MC 46 to access the DIMMS 15 and 16. The packet determining unit 45a waits for a result of the accessing to be reported from the MC 46, and then instructs the request converting unit 45c to generate a packet that will serve as a response. The generated packet is output to the global system bus 2 via the selector 45e or is transmitted to a corresponding CPU via the selector 45d and a corresponding packet transmitting unit 42. “NC DIMM ACCESS” in FIG. 4 is an access to write data to the DIMMS 15 and 16 or to read data from the DIMMS 15 and 16.

Upon receipt of a packet from the packet receiving unit 41 or 43, the packet determining unit 45a outputs the received packet to the trace record circuit 47. In the present embodiment, only the header division (FIG. 2) of the packet is on object stored as history information. The header division of packets will hereinafter be referred to as “trace data”, and descriptions will be given on the assumption that the packet determining unit 45a outputs only trace data to the trace record circuit 47. Note that trace data may be the entirety of a packet. In this case, data that is an object to be stored does not need to be extracted from the packet. Trace data may be a header division with a portion of it removed.

The trace record circuit 47 temporarily saves, as history information, trace data input from the packet determining unit 45a; alternatively, the trace record circuit 47 generates another piece of history information using the trace data and stores this piece of history information in the DIMMS 15 and 16 via the MC 46. “WRITE REQUEST” in FIG. 4 is a request to store history information in the DIMMS 15 and 16. Settings related to generated history information and to the storing of the history information in the DIMMS 15 and 16 maybe made using the management board 21 connected to the SC 48. Alternatively, the CPU 11 may cause the packet controlling unit 45 to make the settings.

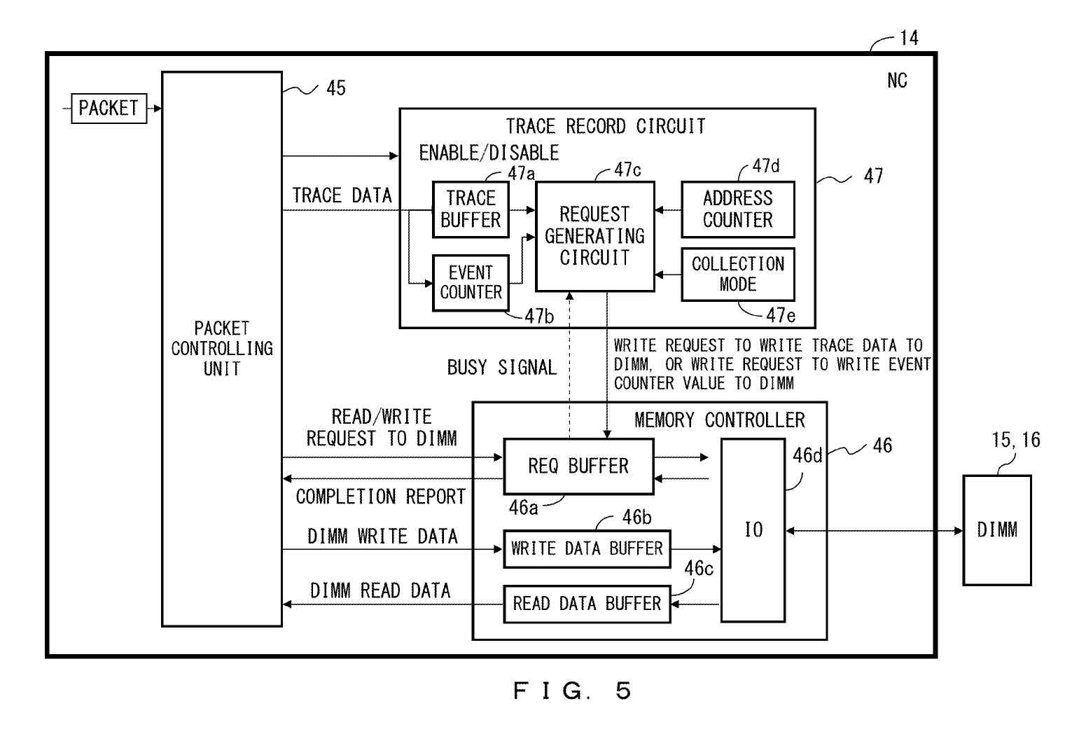

FIG. 5 illustrates a configuration of a trace record circuit and an MC.

The trace record circuit 47 includes a trace buffer 47a, an event counter 47b, a request generating circuit 47c, an address counter 47d, and a collection mode register 47c. “TRACE DATA” in FIG. 5 is data that may possibly be stored as history information. As described above, in this example, the header division of a packet corresponds to “TRACE DATA”.

The trace buffer 47a temporarily saves data that is included in a packet and that is to be stored as history information. In the present embodiment, only a header division of a packet, i.e., trace data is temporarily saved.

The event counter 47b counts the number of times a predesignated type of packet emerges. In the present embodiment, a count value (a calculation value) of the event counter 47b is also storable as history information. The count value is cumulative (statistical) information that indicates a frequency with which a specific packet emerges.

As illustrated in FIG. 3, history information is stored in the trace recording region provided in the DIMMS and 16. In the present embodiment, when history information is stored at the addresses up to the upper limit address of the DIMMS 15 and 16, history information is recorded (overwritten) at addresses starting from the start address. The address counter 47d serves to achieve the cyclic storing of history information in the trace recording region. The collection mode register 47e is used to store a value indicating a collection mode related to the recording (collecting) of history information.

In the present embodiment, two kinds of collection modes are prepared. One is a trace prioritizing mode to prioritize the collecting of history information, and the other is an access prioritizing mode to prioritize an access to the DIMMS 15 and 16. While the trace prioritizing mode is set, a logical value of 1 is stored in the collection mode register 47e; while the access prioritizing mode is set, a logical value of 0 is stored in the collection mode register 47e. A “logical value” may hereinafter be simply referred to as a “value”.

In accordance with the value stored in the collection mode register 47e, the request generating circuit 47c selects, as an object to be stored in the DIMMS 15 and 16, any of the trace data saved in the trace buffer 47a and the count value of the event counter 47b.

Both the trace data and the count value are history information that indicates a packet relay operation. However, they have largely different data amounts. When, for example, 1 byte, 1 byte, 0.5 byte, 0.5 byte, and 5 bytes are respectively assigned to a destination ID, a source ID, a UID, a request type, and an address, the entirety of the header division stored as the trace data is data of eight bytes. Thus, for each packet, an eight-byte region is needed to store history information.

By contrast, assigning, for example, four bytes to the count value allows 4.2×10⁹ packets or more to be addressed. Thus, even though many event counters 47b are prepared, the amount of the entire data is significantly suppressed in comparison with a situation in which trace data using the header division is stored for each packet. As a result, in comparison with a situation in which trace data is stored for each packet, a frequency with which the DIMMS 15 and 16 are accessed may be significantly suppressed.

Accordingly, in the present embodiment, trace data is recorded as history information in the trace prioritizing mode, and a count value is recorded as history information in the access prioritizing mode. Thus, even when the DIMMS 15 and 16 are conentratedly accessed, i.e., even when a request to allow an access to the DIMMS 15 and 16 is made a great many times per unit time, history information may be collected while suppressing the degree of the concentration of the access. Accordingly, for a CPU 11 to which the DIMMS 15 and 16 are available, inhibition of an access to the DIMMS 15 and 16 due to the recording of history information is suppressed. As a result, even though the DIMMS 15 and 16 used by the CPU 11 are used to record history information, a decrease in the processing speed of the CPU 11 and, furthermore, a decrease in the processing speed of the entirety of the data processing apparatus are suppressed.

When a plurality of pieces of trace data are storable in unit data to write data to the DIMMS 15 and 16, storing only one piece of trace data in one piece of unit data is not efficient. Accordingly, in the present embodiment, the trace buffer 47a is also used for an application to assemble trace data that corresponds to unit data for the DIMMS 15 and 16. Here, for convenience, descriptions will be given on the assumption that unit data is composed of 64 bytes and one piece of trace data is composed of 8 bytes. In accordance with this assumption, at most eight pieces of trace data are storable in one piece of unit data.

The trace record circuit 47 that has the aforementioned configuration may be operated in accordance with a setting that is made via the packet controlling unit 45. “ENABLE/DISABLE” in FIG. 5 indicates that a setting can be made whether or not to validate the recording of history information.

The MC 46 includes a request buffer (referred to as a “REQ BUFFER” in FIG. 5) 46a, a write data buffer 46b, a read data buffer 46c, and an IO unit 46d.

The request buffer 46a is capable of storing a plurality of pieces of request data that indicate a content of a request. The write data buffer 46b is capable of storing a plurality of pieces of data to be stored in the DIMMS 15 and 16. The read data buffer 46c is capable of storing a plurality of pieces of data read from the DIMMS 15 and 16. The IO unit 46d is an apparatus that references request data stored in the request buffer 46a and accesses the DIMMS 15 and 16 in accordance with the request data.

Request data stored in the request buffer 46a indicates, for example, at least a type of an access and an address to be accessed. Request data output from the packet controlling unit 45 (referred to as “DIMM READ/WRITE REQUEST” in FIG. 5) is generated by, for example, the header division of a packet. Data stored in the data division of a packet may be data to be stored in the write data buffer 46b (referred to as “DIMM WRITE DATA” in FIG. 5). Data read from the read data buffer 46c (referred to as “DIMM READ DATA” in FIG. 5) may be data to be stored in the data division of a packet.

The IO unit 46d obtains unprocessed request data from the request buffer 46a and gains an access designated by the obtained request data to the DIMMS 15 and 16. As an example, when the request data designates a write access, the IO unit 46d obtains data from a corresponding entry of the write data buffer 46b and writes the obtained data at an address of a memory area of the DIMMS 15 and 16 designated by the request data. When the request data designates a read access, the IO unit 46d reads data stored at an address of a memory area of the DIMMS 15 and 16 designated by the request data and writes the read data in a corresponding entry of the read data buffer 46c. In this way, the IO unit 46d gains the access designated by the request data and then reports to the request buffer 46a the completion of the access. In response to the report, the request buffer 46a outputs to the packet controlling unit 45 a completion report that is a message to report the completion of a requested access.

The completion report is generated using, for example, request data.

The request generating circuit 47c of the trace record circuit 47 generates request data using an address value output by the address counter 47d and outputs the generated request data to the MC 46. The output request data is stored in an empty entry of the request buffer 46a of the MC 46. Trace data stored in the trace buffer 47a and a count value of the event counter 47b are output to the MC 46 as data to be stored in the write data buffer 46a.

For example, when all of the entries in which request data is to be stored are occupied or when the number of empty entries becomes equal to or lower than a set value, the request buffer 46a activates a busy signal that indicates this fact. The activated busy signal is inactivated when the number of empty entries becomes equal to or higher than the set value.

Accordingly, when a busy signal is active, the DIMMS 15 and 16 are intensively accessed. In such a situation, it is desirable to not prevent a CPU 11 from accessing DIMMS 15 and 16. Thus, in the present embodiment, when a busy signal is active, irrespective of whether the collection mode has been set, the count value of the event counter 47b is stored as history information. Accordingly, when the busy signal is active, an access from the CPU 11 to the DIMMS 15 and 16 is prioritized to suppress a decrease in the processing speed of the CPU 11. History information to be recorded in the DIMMS 15 and 16 is automatically selected as described above, so that a situation of an access to the DIMMS 15 and 16 that are used for a plurality of applications can be adequately addressed. As an example, a busy signal indicates a logical value of 1 when it is active, and indicates a logical value of 0 when it is inactive.

A busy signal may possibly become active when trace data is present that has not been stored in the trace buffer 47a. Accordingly, in the present embodiment, the request buffer 47a actives the busy signal when the number of vacant entries in which request data is to be stored becomes equal to or lower than a set value. Accordingly, when the busy signal is activated, the request generating circuit 47c causes trace data stored in the trace buffer 47a to be stored in the DIMMS 15 and 16.

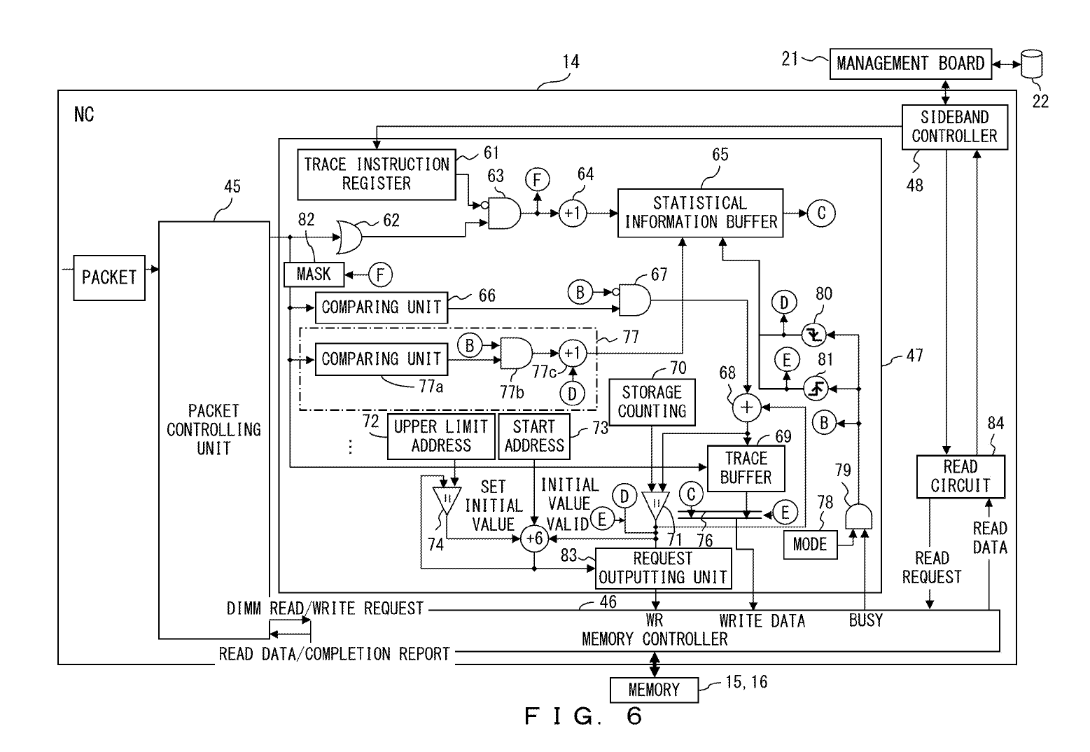

FIG. 6 illustrates a specific exemplary configuration of a trace record circuit. Next, a specific configuration of the trace record circuit 47 will be described in detail with reference to FIG. 6.

Trace data input from the packet controlling unit 45 is output to an OR gate 62. The OR gate 62 outputs, for example, the logical sum of bit values of the trace data to an AND gate 63. The logical value of any of the bits of the trace data is 1. Accordingly, when trace data is input from the packet controlling unit 45, the OR gate 62 outputs the logical sum of a logical value of 1.

In addition to the logical sum output from the OR gate 62, the AND gate 63 receives a value that is an inversion of a value stored in a trace instruction register 61 and outputs a logical product to a counter 64. The trace instruction register 61 is capable of storing data of a plurality of bits, and is used to make a setting regarding whether or not to record history information.

As an example, in the storing of one-bit data in the trace instruction register 61, “0” is stored to record history information and “1” is stored to not record history information. One-bit value is inverted and input to the AND gate 63. Thus, when a setting is made to not record history information, the value of a logical product output by the AND gate 63 is always 0. When a setting is made to record history information, the value of a logical sum output by the OR gate 62 is 1, so the value of a logical product output by the AND gate 63 is 1.

The counter 64 increments the count value every time the value of a logical product output by the AND gate 63 becomes 1. Thus, the count value of the counter 64 is identical with the number of pieces of trace data output from the packet controlling unit 45 to the trace record circuit 47. When the count value reaches an upper limit, the counter 64 sets 0 as the count value. Accordingly, the counter 64 cyclically calculates the number of pieces of trace data output from the packet controlling unit 45 to the trace record circuit 47. The count value of the counter 64 is output to a statistical information buffer 65.

Trace data input from the packet controlling unit 45 is also output to a mask circuit 82. The mask circuit 82 outputs the input trace data when the value of the logical product output by the AND gate 63 is 1. The trace data output from the mask circuit 82 is input to a comparing unit 66, a plurality of event counters 77, and a trace buffer 69.

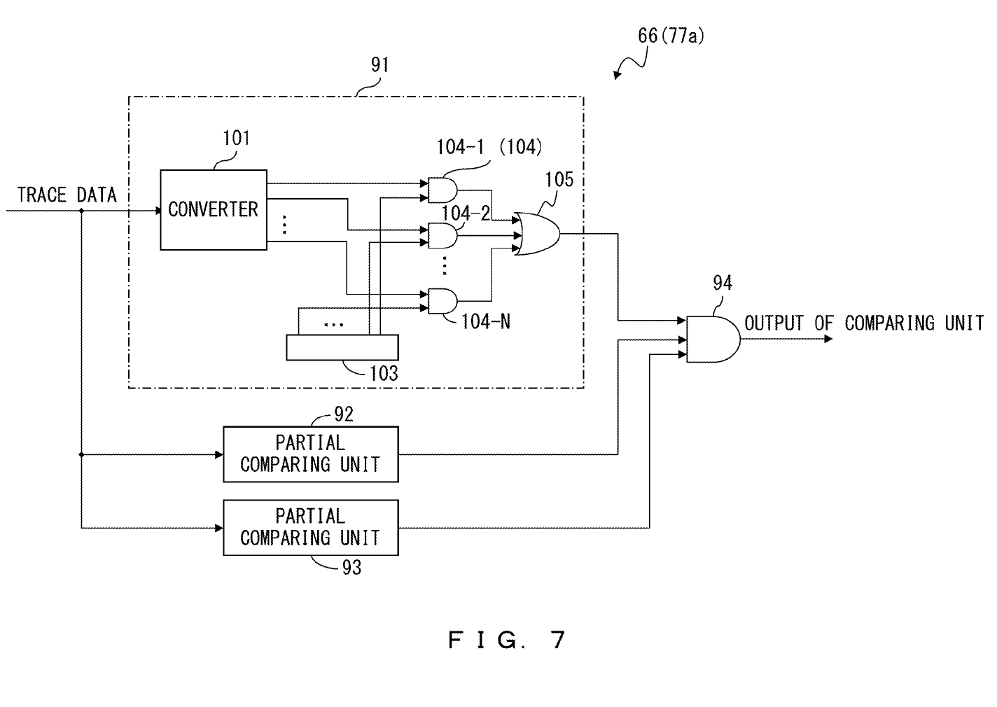

The comparing unit 66 serves to extract, from pieces of trace data output by the packet controlling unit 45, apiece of trace data that can be an object to be recorded as history information. In particular, a configuration such as illustrated in FIG. 7 is used. Next, with reference to FIG. 7, the configuration of the comparing unit 66 will be described in detail.

As illustrated in FIG. 7, the comparing unit 66 includes three partial comparing units 91 to 93 and an AND gate 94 that determines the logical product of output signals of the partial comparing units 91 to 93. The logical product output by the AND gate 94 corresponds to an output signal of the comparing unit 66.

Trace data, i.e., the header division of a packet, has a configuration as illustrated in FIG. 2. Accordingly, in the present embodiment, trace data that can be an object to be recorded as history information may be designated in accordance with the combination of a destination ID, a source ID, and a request type. Thus, for destination IDs, source IDs, and request types, the three partial comparing units 91 to 93 are provided to determine whether or not trace data has been designated. For convenience, descriptions will be given on the assumption that the three partial comparing units 91 to 93 are respectively designed for destination IDs, source IDs, and request types.

A convertor 101 of the partial comparing unit 91 extracts a destination ID within trace data and converts the extracted destination ID in a manner such that only one bit of a plurality of bits of the destination ID is indicated as 1. To achieve such conversion, when one byte is allocated to the destination ID, the convertor 101 converts the destination ID by setting only one bit of the 256 bits as 1. When, for example, the value of the destination ID is 0, only the value of the least significant bit of the 256 bits of the destination ID is set as 1. When the value of the destination ID is 1, only the value of the second-least significant bit of the 256 bits of the destination ID is set as 1. When the value of the destination ID is 255, only the value of the most significant bit of the 256 bits of the destination ID is set as 1. The value of each bit output by the convertor 101 is output to an AND gate 104 with which the bit is associated. As an example, the value of the least significant bit of the destination ID is output to an AND gate 104-1, and the value of the second-least significant bit is output to an AND gate 104-2. As many converters 101 as the number of bits of the destination ID (=256) are present, so N in “AND gates 104-1 to 104-N” is 256.

As many pieces of data as the number of bits of a destination ID are storable in a register 103. The register 103 stores, for example, data that designates a bit to be validated from among the bits of the destination ID. In a situation in which the converter 101 outputs the values of 256 bits as described above, in order to address, for example, only trace data with a destination ID of 0, data in which only the least significant bit indicates 1 is stored in the register 103. In order to address trace data for all of the destination IDs, data in which all of the bit values are 1 is stored in the register 103.

Each bit value in the register 103 is input to an AND gate 104 with which the bit value is associated. As a result, the value of the least significant bit in the register 103 is input to the AND gate 104-1. Accordingly, each AND gate 104 outputs the logical product of the value of one bit output from the converter 101 and the value of one bit in the register 103. An OR gate 105 receives a logical product output by each AND gate 104 and outputs the logical sum of the received logical products. The logical sum is input to the AND gate 94 as an output signal of the partial comparing unit 91.

To record trace data having a specific destination ID, the operator, i.e., the user, designates the value of the destination ID. In accordance with the designating of the value, data that depends on the designated value is stored in the register 103. Accordingly, the value of the logical product output by one of the AND gates 104-1 to 104-N is 1, and the logical sum output by the OR gate 105 is 1. As a result, when the selection of trace data is valid, the partial comparing unit 91 outputs a signal with a value of 1 in accordance with the inputting of the trace data having the destination ID designated by the register 103 to the comparing unit 66.

When data in which all of the bits are 0 is stored in the register 103, irrespective of the bit value output by the converter 101, the value of the logical product output by each of the AND gates 104-1 to 104-N is 0. Thus, the value of a logical sum output by the OR gate 105 is also always 0.

The configuration of the partial comparing units 92 and 93 is similar to that of the partial comparing unit 91. Accordingly, the partial comparing units 92 and 93 will be described using, for convenience, the reference numerals assigned to the elements of the partial comparing unit 91.

When the selection of trace data is valid, the partial comparing unit 92 outputs a signal of a value of 1 in accordance with the inputting of trace data having a source ID designated by the register 103. Similarly, the partial comparing unit 93 outputs a signal of a value of 1 in accordance with the inputting of trace data having a request type designated by the register 103. Accordingly, the logical product output by the AND gate 94, i.e., the value of a signal output by the comparing unit 66, becomes 1 in accordance with the inputting of trace data having a destination ID, a source ID, and a request type, all of which are designated in advance.

The comparing unit 66 configured and operated as described above is also included in the event counter 77 as a comparing unit 77a. Accordingly, the comparing unit 77a will be described using, for convenience, the reference numerals assigned to the elements of the partial comparing unit 91.

As with the comparing unit 66, the comparing unit 77a of each event counter 77 outputs a signal of a value of 1 in accordance with the inputting of trace data having a destination ID, a source ID, and a request type, all of which are designated by the operator. When a register 103 of any of the three partial comparing units 91 to 93 of the comparing unit 77a indicates a value of 0, the value of an output signal of the comparing unit 77a is always 0.

The output signal of the comparing unit 77a is input to an AND gate 77b. The AND gate 77b outputs the logical product of the output signal of the comparing unit 77a and a value that is an inversion of the value of the logical product output by an AND gate 79. The logical product output by the AND gate 79 is output to a counter 77c. The counter 77c increments a count value every time a signal indicating a value of 1 is input. The count value of the counter 77c is cleared by a signal pulse output by a pulse generator 80. The pulse generator 80 outputs a signal pulse when the pulse generator 80 detects a change in the value of the logical product of the AND gate 79 from 1 to 0. Thus, during the trace prioritizing mode, the counter 77c calculates the number of times trace data designated by the operator is input to the trace record circuit 47 for a period from activation of a busy signal to inactivation of the busy signal (hereinafter referred to as a “busy period”). The period during which the counter 77c, i.e., the event counter 77, performs calculation will hereinafter be referred to as a “calculation target period”. When a setting is made to not record history information before busy information becomes inactive, the calculation target period corresponds to a period from activation of a busy signal to completion of the rewriting of the value of the trace instruction register 61 triggered by a change in the setting. The count value of the counter 77c is output to the statistical information buffer 65. The setting to not record history information corresponds to rewriting the value of the trace instruction register 61 from 1 to 0.

The count value of the counter 77c is the number of times trace data provided with a destination ID, a source ID, and a request type, all of which are designated by the operator, is input to the trace record circuit 47 by the comparing unit 77a during the calculation target period. Accordingly, each event counter 77 may calculate the number of pieces of trace data for each operator-designation. For each combination of a destination ID, a source ID, and a request type, each event counter 77 may calculate the number of pieces of trace data. Thus, the count value of each event counter 77 is statistical information that depends on a classification made by the operator.

As described above, when a register 103 of any of the three partial comparing units 91 to 93 of the comparing unit 77a indicates a value of 0, the value of an output signal of the comparing unit 77a is always 0. Thus, the AND gate 77b does not output a logical product indicating a value of 1. Accordingly, the event counter 77 that includes one or more registers 103 storing 0 is not operated. As a result, the registers 103 are used to perform a control to determine whether to or not to operate the event counter 77.

A signal output by the comparing unit 66 is input to an AND gate 67. A logical value output by the AND gate 79 is also input to the AND gate 67. The AND gate 79 outputs the logical product of a busy signal and data stored in a collection mode register 78. The value of data stored in the collection mode register 78 indicates the type of a collection mode that has been set. As described above, a value of 1 is stored in the collection mode register 78 when the trace prioritizing mode has been set, and a value of 0 is stored in the collection mode register 78 when the access prioritizing mode has been set. The value of a busy signal is 0 when the busy signal is active, and the value of the busy signal is 1 when the busy signal is inactive. Thus, the trace prioritizing mode is set when a signal indicating a logical value of 1 has been input from the comparing unit 66, and the AND gate 67 outputs a logical product of 1 when the busy signal has been inactive.

The logical product output by the AND gate 67 is input to a counter 68. The count value output by the counter 68 is input to the trace buffer 69. Trace data is output to the trace buffer 69 via the mask circuit 82.

As described above, data is written to the DIMMS 15 and 16 in units of 64 bytes. A piece of trace data is 8 bytes. In consideration of such a difference in the amount of data, the trace buffer 69 is used to assemble 64 bytes of trace data (=eight pieces of trace data). The count value output by the counter 68 is used to designate a location (a record) within the trace buffer 69 at which trace data is stored. Thus, every time a logical product of 1 is input from the AND gate 67, the counter 68 increments the count value. When, for example, a comparator 71 outputs a signal indicating a value of 1, the count value is cleared, i.e., is set to 0.

The comparator 71 compares the value of data in a storage counting register 70 with the count value of the counter 68, and outputs a signal indicating a value of 1 when the value of data in a storage counting register 70 is identical with the count value of the counter 68. To store eight pieces of trace data in the trace buffer 69, count values of 0 to 7 may be output from the counter 68. Thus, data indicating a value of 7 may be stored in the storage counting register 70. Accordingly, when the counter 68 outputs a count value of 7, the eighth piece of trace data is stored in the trace buffer 69 and the count value is then set to 0.

The output signal of the comparator 71 is input to a counter 75. The counter 75 is used to generate an address within the DIMMS 15 and 16 at which history information is to be stored. Since unit data stored in the DIMMS 15 and 16 is 64 bytes, the counter 75 adds 64 to the count value every time a signal indicating a value of 1 is output from the comparator 71.

The output signal of the comparator 71 is input to a request outputting unit 83. The count value of the counter is also input to the request outputting unit 83. Accordingly, every time a signal indicating a value of 1 is output from the comparator 71, the request outputting unit 83 generates request data using the input count value and outputs this request data to the MC 46.

A start address register 73 and a comparator 74 are connected to the counter 75. The comparator 74 compares the count value output by the counter 75 with a value stored in an upper-limit address register 72, and outputs a signal indicating a value of 1 when the count value output by the counter 75 is identical with the value stored in the upper-limit address register 72.

A value stored as data in the start address register 73 indicates the leading address of a trace recording region secured in the DIMMS 15 and 16 (FIG. 3). A value stored as data in the upper-limit address register 72 indicates a value that is the sum of 1 and the upper limit address of the trace recording region secured in the memories 15 and 16 (FIG. 3). Such a value is stored in the upper-limit address register 72, because data is stored in the DIMMS 15 and 16 in units of 64 bytes.

When the comparator 74 outputs a signal indicating a value of 1, the counter 75 sets a value stored in the start address register 73. Accordingly, the counter 75 functions as a counter that increments the count value in increments of 64 under a condition in which the value of the start address register 73 is an initial value and the value of the upper-limit address register 72 is an upper limit.

Every time a signal that indicates a value of 1 is input, the request outputting unit 83 generates request data that includes the count value of the counter 75 as an address. The counter 75 then adds 64 to the count value. When the count value, to which 64 has been added, is equal to the value of the upper-limit address register 72, the comparator 74 outputs a signal indicating a value of 1, thereby causing the counter 75 to make an initial setting wherein the value of the start address register 73 is a count value. Accordingly, the value stored in the upper-limit address register 72 is the sum of 1 and the upper limit address of the trace recording region.

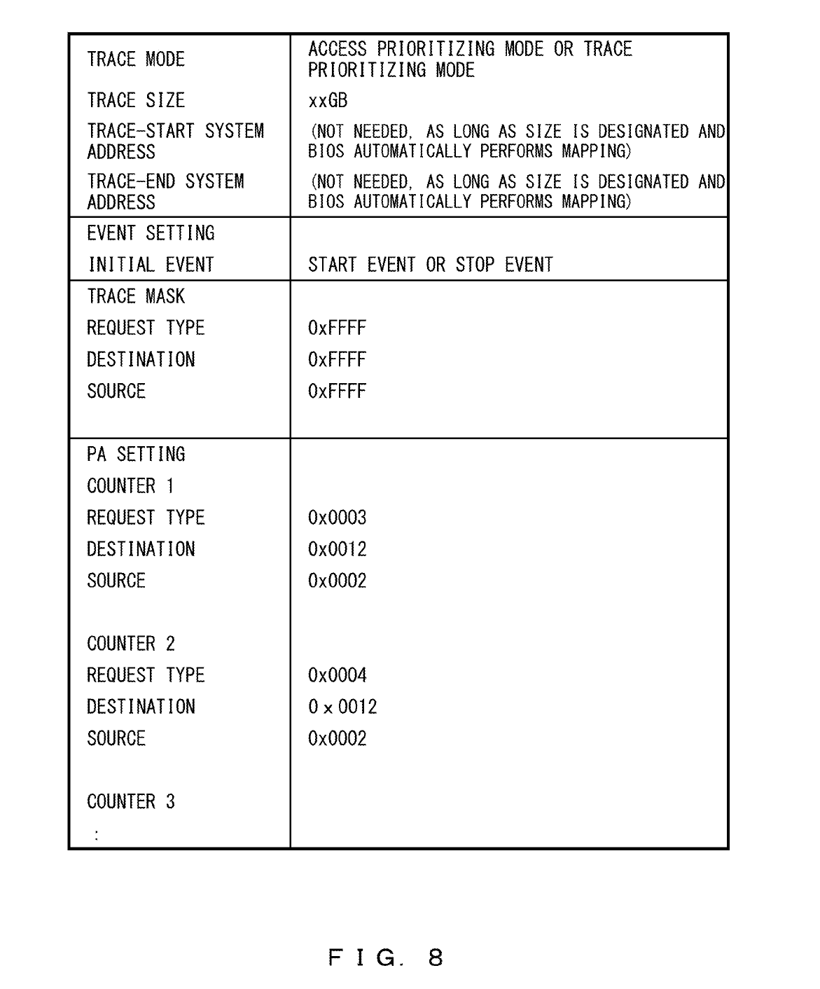

Settings for the comparing unit 66, the event counter 77 (the comparing unit 77a), the trace instruction register 61, the upper-limit address register 72, the start address register 73 are made using a configuration file such as the one illustrated in FIG. 8. More particularly, for example, one of the CPUs 11 installed on the system board 1 references the configuration file and makes settings via the packet controlling unit 45.

As illustrated in FIG. 8, the configuration file has written thereto basic information related to a record of history information, event setting information related to whether to or not to record history information, trace mask information related to trace data to be recorded, and PA (Packet Accumulation) setting information related to statistical information to be obtained.

The basic information includes trace mode information to designate a collection mode to be initially set, trace size information to designate the size of a trace storage region, and address information to designate a trace storage region using a start address and an upper limit address. “TRACE-START SYSTEM ADDRESS” and “TRACE-END SYSTEM ADDRESS” in FIG. 8 respectively indicate address information for a start address and address information for an upper limit address. The content of trace size information maybe specified using address information, and the content of address information may be specified using trace size information, so only one of these two kinds of information needs to be written.

Event information (referred to as “INITIAL EVENT” in FIG. 8) designates a value to be stored in the trace instruction register 61 as an initial value. “START EVENT” and “STOP EVENT” in FIG. 8 respectively indicate a setting to record history information and a setting to not record history information. 0 is written to the trace instruction register 61 while “START EVENT” is being set, and 1 is written to the trace instruction register 61 while “STOP EVENT” is being set.

Trace mask information relates to a setting for the comparing unit 66. The comparing unit 66 may set a destination ID, a source ID, and a request type of an objective packet. Accordingly, an objective destination ID, an objective source ID, and an objective request type may be described as trace mask information using a numerical value.

A destination ID, a source ID, and a request type are described using a numerical value with a result of conversion by the converter 101 in mind. Accordingly, a binary representation of data of the described numerical value is stored in the register 103.

As described above, the converter 101 sets, to 1, only one bit of the bits to be output. Thus, when designation of a packet is validated, a value of one or higher is stored in the register 103. Only one bit of the bits to be output is set to 1, so, under a condition in which the converter 101 expresses a value with 16 bits (under a condition in which the number of bits to be output is 16), “0xFFFF” in FIG. 8 indicates that all packets are recorded. That is, in the case of, for example, the destination ID, the value of trace mask information “0xFFFF” means that all destination IDs are recorded irrespective of the value. In FIG. 8, “0xFFFF” is indicated as a destination ID, a source ID, and a request type. In this example, such an indication means that all pieces of trace data are recorded.

When a value of 0 is written as a trace mask, data that includes only bit values of 0 is stored in a corresponding register 103. When data that includes only bit values of 0 is stored in any of the registers 103 of the comparing units 66, the comparing units 66 do not output a signal indicating a value of 1. Thus, to designate a packet to be recorded, a value of one or higher needs to be described for the destination ID, the source ID, and the request type of trace mask information.

PA setting information is described for each event counter 77. As described above, each event counter 77 includes a comparing unit 77a. The comparing units 77a have basically the same configuration as the comparing units 66. Thus, for PA setting information, an objective destination ID, an objective source ID, and an objective request type are also described using a numerical value for each event counter 77. “COUNTER 1” to “COUNTER 3” each indicate a different event counter 7. To stop the event counter 77 from being operated, 0 may be set as, for example, at least one of the values of the destination ID, the source ID, and the request type of PA setting information. Information may be prepared to select an event counter 77 to be validated.

FIG. 6 will be described again.

In response to input of request data, the MC 46 captures data to be stored in the DIMMS 15 and 16. The input request data is stored in the request buffer 46a, and the captured data is stored in the write data buffer 46b (FIG. 5).

The data captured by the MC 46 is output from a selector 76. The selector 76 selects and outputs one of data in the trace buffer 69 and data in the statistical information buffer 65.

The count value of the counter 64 and the count value of each event counter 77 are output to the statistical information buffer 65, and a count value that depends on a signal pulse output by each of the pulse generators 80 and 81 is captured.

The pulse generator 80 detects a change in the value of the logical product of the AND gate 79 from 1 to 0 and outputs a signal pulse. By contrast, the pulse generator 81 detects a change in the value of the logical product of the AND gate 79 from 0 to 1 and outputs a signal pulse. Accordingly, during the trace prioritizing mode, the pulse generator 81 outputs a signal pulse when an active busy signal becomes inactive.

In response to the signal pulse output by the pulse generator 80, the statistical information buffer 65 captures the count value of the counter 64. In response to the signal pulse output by the pulse generator 81, the count value of the counter 64 and the count value of each event counter 77 are captured. The count value of the counter 64 is captured in response to the signal pulse output by the pulse generators 80 and 81, so that, during the calculation target period, e.g., the period during which the busy signal is active, the number of pieces of trace data output to the trace record circuit 47 can be specified. Accordingly, the proportion of the trace data for which calculation has been performed by each event counter 77 to the trace data output to the trace record circuit 47 may be recognized.

The selector 76 ordinarily selects data in the trace buffer 69; when the pulse generator 81 outputs a signal pulse, the selector 76 selects data in the statistical information buffer 65. The signal pulses output by the pulse generators 80 and 81 are respectively input to the request outputting unit 83 and the counter 64. Thus, when the pulse generator 80 outputs a pulse signal in response to activation of a busy signal, the request outputting unit 83 outputs request data to the MC 46, and data within the trace buffer 69 is captured by the MC 46 via the selector 76. Subsequently, when the pulse generator 81 outputs a pulse signal in response to inactivation of a busy signal, the request outputting unit 83 outputs request data to the MC 46, and data within the statistical information buffer 65 is captured by the MC 46 via the selector 76.

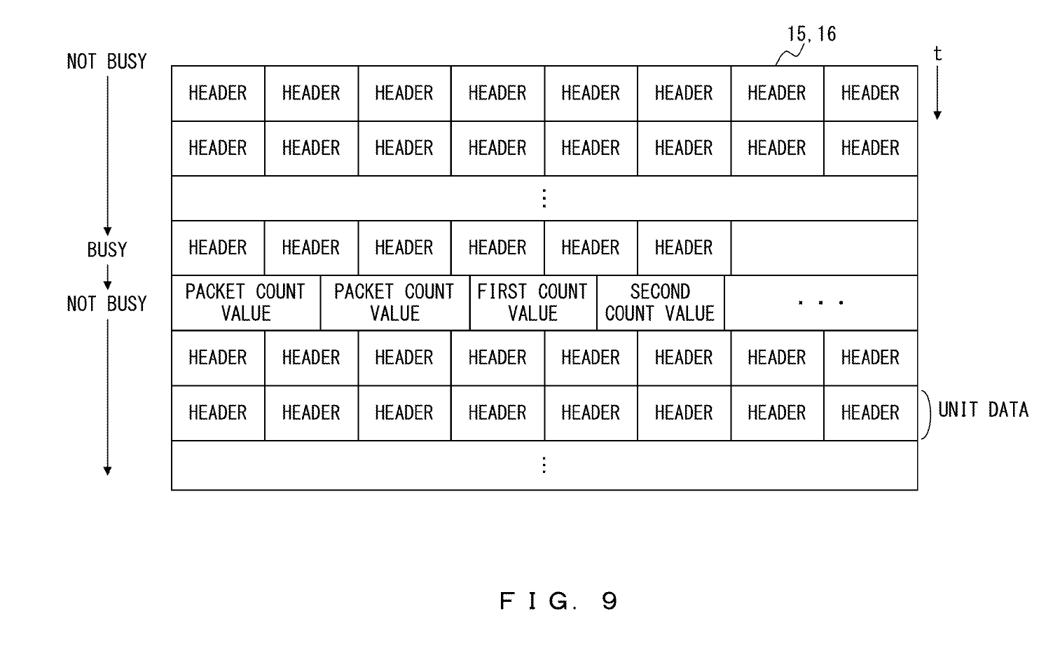

FIG. 9 illustrates history information recorded in the DIMMS 15 and 16. “NOT BUSY” and “BUSY” in FIG. 9 respectively indicate an inactive busy signal and an active busy signal. Each line indicates unit data written to the

DIMMS 15 and 16 in one operation. FIG. 9 depicts history information written to the DIMMS 15 and 16 as unit data for each state and each change in the state when the state of a busy signal sequentially changes during the trace prioritizing mode in the order of the inactive state→the active state→the inactive state.

As illustrated in FIG. 9, when a busy signal is inactive, eight pieces of trace data, i.e., header divisions of eight packets, are written to the DIMMS 15 and 16 as one piece of unit data. When the busy signal is activated, pieces of trace data stored at that moment in the trace buffer 64 are written to the DIMMS 15 and 16 as one piece of unit data. Referring to FIG. 9, when the busy signal is activated, one piece of unit data includes only six pieces of trace data.

When the busy signal is activated, the count value of the counter 64 is stored in the statistical information buffer 65. Subsequently, when the busy signal is inactivated, the count value of the counter 64 and the count value of each event counter 77 are stored in the statistical information buffer 65, and data stored in the statistical information buffer 65 is output to the MC 46 via the selector 76. Accordingly, data stored in the statistical information buffer 65 is written to the DIMMS 15 and 16 as one piece of unit data. Referring to FIG. 9, the “PACKET COUNT VALUE” on the left indicates the count value of the counter 64 that has been stored in the statistical information buffer 65 in response to activation of the busy signal, and the “PACKET COUNT VALUE” on the right indicates the count value of the counter 64 that has been stored in the statistical information buffer 65 in response to inactivation of the busy signal. “FIRST COUNT VALUE” and “SECOND COUNT VALUE” each indicate the count value of a different event counter 77.

As illustrated in FIG. 9, when the busy signal becomes active, the trace record circuit 46 makes a request to write data (history information) only once before the busy signal becomes inactive. This one request causes the trace data stored in the trace buffer 69 to be written to the DIMMS 15 and 16. Thus, disturbance of accesses from the CPUs 11 to the DIMMS 15 and 16 may be significantly suppressed. Accordingly, the performance degradation of the data processing apparatus associated with the recording of history information may be minimized.

During the access prioritizing mode, the value of the logical product output by the AND gate 79 is always 0 irrespective of the value of a busy signal. Thus, although each event counter 77 maybe caused to perform counting, the count value of each event counter 77 is not simply recorded in the DIMMS 15 and 16. As a result, accesses from the CPUs 11 to the DIMMS 15 and 16 may be prevented from being disturbed due to the recording of history information. Accordingly, for the system board 1 that relays many packets, the access prioritizing mode may be set for the NC 14. FIG. 6 does not depict the elements to record the count value of each event counter 77 in the DIMMS 15 and 16 during the access prioritizing mode, but the management board 21 is capable of obtaining the count value of each event counter 77.

Although not illustrated in FIG. 5 and FIG. 6, the NC 14 includes a read circuit 84 to read data from the DIMMS 15 and 16 via the MC 46. The read circuit 84 is connected to the sideband controller 48, and, in accordance with a request from an apparatus that is capable of communicating with the sideband controller 48 (in this example, the management board 21), the read circuit 84 outputs to the MC 46 request data (referred to as “READ REQUEST” in FIG. 6) to make a request to read data. Data obtained via the outputting of the request data is output from the read circuit 84 to the sideband controller 48 and is transmitted via the sideband controller 48 to the management board 21 that has made a request to read data.

As described above, the apparatus connected to the NC 14, i.e., the management board 21, may access the DIMMS 15 and 16 via the NC 14. Thus, the management board 21 may access the DIMMS 15 and 16 without causing the CPU 11 to perform a process of accessing the DIMMS 15 and 16. As a result, when history information recorded in the DIMMS 15 and 16 is obtained, execution of the process is not disturbed by any of the CPUs 11 on the system boards 1. Accordingly, making a connected external apparatus accessible directly to the DIMMS 15 and 16 via the NC 14 may better prevent the processing speed of the entirety of the data processing apparatus from decreasing.

FIG. 6 depicts an arrow that extends from the SC 48 to the trace instruction register 61. This indicates that the value of the trace instruction register 61 may be written via the SC 48 by operating the management board 21. The values of various registers which the trace record circuit further includes may be rewritten via the SC 48. Accordingly, the operator may change on an as-needed basis the type of trace data to be recorded and the type of trace data to be counted.

The correspondence between the configuration illustrated in FIG. 6 and the configuration illustrated in FIG. 5 is as follows, for example. In particular, the trace buffer 47a corresponds to the trace buffer 69. The event counter 47b corresponds to all of the event counters 77. The address counter 47d corresponds to the upper-limit address register 72, the start address register 73, and the counter 75. The collection mode register 47e corresponds to the collection mode register 78. Other elements of the trace record circuit 47 in FIG. 6 correspond to the request generating circuit 47c.

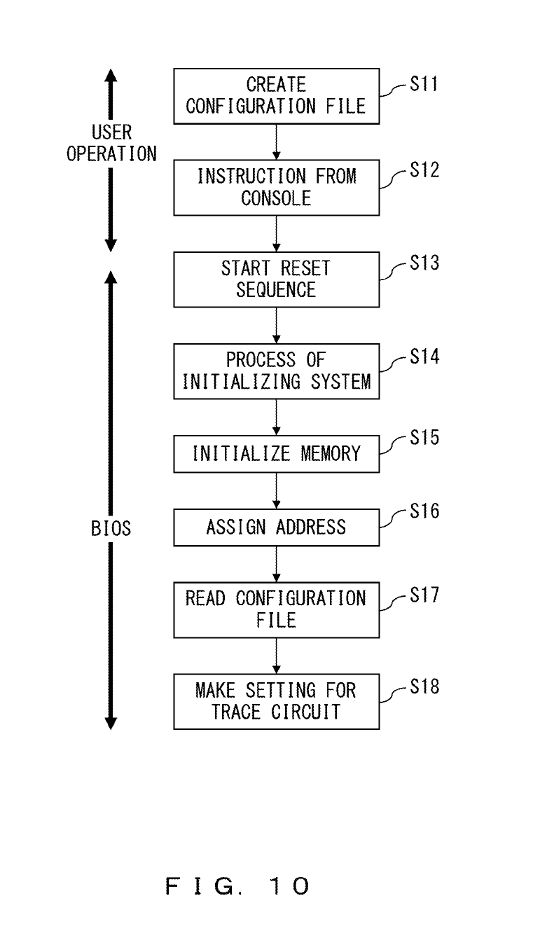

As described above, settings for the trace record circuit 47 are made by referencing the configuration file illustrated in FIG. 8. Next, with reference to FIG. 10, descriptions will be given in detail of an operation to make a setting for the trace record circuit 47. FIG. 10 is a flowchart illustrating the flow of processes performed to make a setting for the trace record circuit 47. FIG. 10 is based on the assumption that, during starting, one CPU 11 of each system board 1 makes a setting for the trace record circuit 47 by reading a configuration file stored at a storage location preset by the BIOS.

When a configuration file is not present at the storage location, the operator operates, for example, the management board 21 so as to create a configuration file at the storage location and describe a desired content in this configuration file as information. When a configuration file is already present at the storage location, the configuration file is edited, and the description of information to be changed is updated. In this way, a configuration file with a desired content is prepared (the process described so far corresponds to S11).

The CPU 11 into which the BIOS has been loaded may obtain data from any of the storages present on another system board 1 (e.g., the storages 17 and 18 illustrated in FIG. 1) and from any of the storages 22 to which the management board 21 is accessible. Thus, the storage location of the configuration file is not particularly limited. In an arrangement such that a configuration file is read from the storage 22, even when the data processing apparatus is turned off, a configuration file may be created and edited.

The operator, who has prepared a configuration file with a desired content, causes, for example, the management board 21 to give an instruction to reset the data processing apparatus (S12). The “reset” here means, for example, turning on or restarting the data processing apparatus. The instruction to reset may be given using, if any, a console that is different from the management board 21. If possible, the configuration file may be created or edited using a console that is different from the management board 21 without using the management board 21.

In accordance with the aforementioned instruction to reset, each CPU 11 of each system board 1 performs a restarting operation and has the BIOS loaded thereinto (S14). The CPU 11, into which the BIOS has been loaded, performs a process of initializing the system, including, for example, introducing of a required program (driver) (S12), and the CPU 11 tests and initializes the DIMMS 12 and 13 and, additionally, the DIMMS 15 and 16 (S13). Subsequently, the CPU 11 allocates a trace recording region (FIG. 3) available to the NC 14 within the DIME 15 and 16 (S16). The allocation is a default setting that is made in accordance with a preset content, and the allocation stores a value in the upper-limit address register 72 and the start address register 73 of the trace record circuit 47. The value is stored in the upper-limit address register 72 and the start address register 73 via the packet controlling unit 45.

Next, the CPU 11 reads a configuration file from a preset storage location (S17). The CPU 11, which has obtained the configuration file from the reading, makes a setting for the trace record circuit 47 in accordance with the configuration file (S18). In accordance with the setting, a value is stored in various registers of the trace record circuit 47 via the packet controlling unit 45. Thus, when a value of 0 is stored in the trace instruction register 61, in accordance with the value stored in the collection mode register 78, trace data starts to be stored in the trace buffer 69, or the event counter 77 starts to count.

Referring to the processes illustrated in FIG. 10, in accordance with an operation by the user (the operator) with a console such as the management board 21, S11 and S12 are performed by the console. In accordance with an instruction from the user (the operator), S13 to S18 are performed by the CPU 11 into which the BIOS are loaded. S13 to S18 are also performed by the CPU 11 upon turning on the data processing apparatus. If necessary, S17 and S18 may be performed by the management board 21.

In the present embodiment, while the trace prioritizing mode is being set, the event counters 77 performs calculating only during the busy period, because trace data is recorded as history information during the period other than the busy period, i.e., because the packets received by the NC 14 during the period other than the busy period may be specified using trace data that has been recorded. However, the event counters 77 may also perform calculating during the busy period, and count values may be recorded at certain time intervals, for example. The count values may be recorded in accordance with a change in the busy signal from inactive to active.

The count values of the event counter 77 are directly recorded in the statistical information buffer 65. This is because the count value of the counter 64 is recorded both when the busy signal becomes active and when the busy signal becomes inactive. This is because, using the number of pieces of trace data output from the packet controlling unit 45 to the trace record circuit 47 during the busy period during which the busy signal is active, an element such as a frequency with which trace data counted by each event counter 77 emerges can be specified. However, the frequency, i.e., the proportion of the trace data counted by the event counter 77 to the entirety may be represented using fewer bits than the count value, so, instead of the count value, the frequency or another element may be recorded as statistical information. The number of pieces of trace data may be calculated by the counter 64 during the busy period so as to record only one count value of the counter 64.

Information to be recorded as history information is switched with the busy signal output by the MC 46 (FIG. 5) in mind. This is because the busy signal is information that precisely indicates the presence/absence of a capability to make a request to allow the DIMMS 15 and 16 to be accessed. As the number of packets that the NC 14 receives per unit time increases, the DIMMS 15 and 16 are considered to be accessed more often. Accordingly, the presence/absence of a capability to make a request to allow the DIMMS 15 and 16 to be accessed may be determined from, for example, the result of calculating, for each unit time, the number of pieces of trace data output to the trace record circuit 47 by the packet controlling unit 45.

The data processing apparatus in accordance with the present embodiment is configured in a manner such that the system board 1 is connected to the plurality of global system buses 2, but may be configured in a manner such that a plurality of processing apparatuses, not including the system board 1, may be connected. The processing apparatus that actually generates packets is not limited to a CPU. The processing apparatus may be, for example, a GPU (Graphics Processing Unit). The relaying apparatus may receive a packet directly from a CPU or a GPU.

In accordance with a situation of an access to a memory used for a plurality of applications, one system to which the present invention has been applied allows history information that indicates operations of relaying communication unit data to be recorded in the memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A relaying apparatus comprising:
an information extracting unit configured to, when communication unit data transmitted from a processing apparatus that performs data processing is received, extract preset data from the received communication unit data as trace information;
an access unit configured to access a storage apparatus available to the processing apparatus;
a calculating unit configured to calculate the number of pieces of the received communication unit data; and
an information selecting unit configured to select, as history information of the received communication unit data, an object to be stored in the storage apparatus from among the trace information extracted by the information extracting unit and statistical information obtained from a calculation result of the calculating unit, and configured to cause the access unit to store the selected history information in the storage apparatus.

2. The relaying apparatus according to claim 1, wherein
the information extracting unit extracts trace information of a piece of communication unit data selected from pieces of the received communication unit data in accordance with a preset content.

3. The relaying apparatus according to claim 1, wherein
the calculating unit sorts pieces of the received communication unit data into predesignated types and calculates the number of the sorted pieces of the received communication unit data for each of the types.

4. The relaying apparatus according to claim 1, the relaying apparatus further comprising:
an information obtaining unit configured to obtain situation information indicating a situation in which the storage apparatus is accessed, wherein
according to the situation information obtained by the information obtaining unit, the information selecting unit selects an object to be used as the history information from the trace information and the statistical information.

5. The relaying apparatus according to claim 4, wherein
the access unit includes a storage unit that stores request data indicating a content of an access to the storage apparatus,
the information obtaining unit obtains, as the situation information, a requirement amount information that indicates whether or not the number of pieces of unprocessed request data from among the request data stored in the storage unit is equal to or higher than a predetermined number, and
the information selecting unit selects the trace information or the statistical information as the history information in accordance with whether or not the number of pieces of unprocessed request data indicated by the request amount information obtained by the information obtaining unit is equal to or higher than the predetermined number.

6. The relaying apparatus according to claim 1, the relaying apparatus further comprising:
a communication unit configured to communicate with a connected external apparatus; and
an access controlling unit configured to, when the communication unit receives from the external apparatus a request to read data from the storage apparatus, cause the access unit to read the data from the storage apparatus, and to output the read data to the communication unit so as to transmit this read data via the communication unit to the external apparatus.

7. A relay history recording method for recording a relay history by using a relaying apparatus that receives and relays communication unit data transmitted from a processing apparatus, the relay history recording method comprising:
extracting preset data from the received communication unit data as trace information when the communication unit data transmitted from the processing apparatus is received;
calculating the number of pieces of the received communication unit data for each predesignated type; and
storing, as history information of the relay, an object selected from statistical information obtained from the trace information and a result of the calculating for each of the types in a storage apparatus which the relaying apparatus is capable of accessing.

8. A data processing apparatus comprising:
a plurality of processing apparatuses configured to perform data processing;
a storage apparatus available to one or more of the plurality of processing apparatuses; and
a relaying apparatus including
an information extracting unit configured to, when communication unit data transmitted from a processing apparatus that performs data processing is received, extract preset data from the received communication unit data as trace information,
an access unit configured to access a storage apparatus available to the processing apparatus,
a calculating unit configured to calculate the number of pieces of the received communication unit data, and
an information selecting unit configured to select, as history information of the received communication unit data, an object to be stored in the storage apparatus from among the trace information extracted by the information extracting unit and statistical information obtained from a calculation result of the calculating unit, and configured to cause the access unit to store the selected history information in the storage apparatus.
